(19) United States
(12) Patent Application Publication
(10) Pub. No.: US 2012/0176016 A1
(43) Pub. Date: Jul. 12, 2012

(54) CORE-SHELL PARTICULATES, ARTICLES, AND METHOD OF MAKING

(75) Inventors: Peter John Bonitatibus, JR., Saratoga Springs, NY (US); Vikas Midha, Clifton Park, NY (US)

(73) Assignee: General Electric Company, Schenectady, NY (US)

(21) Appl. No.: 11/863,942

(22) Filed: Sep. 28, 2007

(51) Int. Cl. H01J 1/63; H01J 7/24; B32B 5/16; B05D 7/14; B82Y 30/00

(52) U.S. Cl. 313/46; 428/403; 427/216; 977/773

(57) ABSTRACT

A core-shell particulate is provided. The core-shell particulate includes a metal core particulate including a noble metal or a refractory metal; and a ceramic shell including a transition metal composition. The transition metal composition includes a material including hafnium, or zirconium, or yttrium, or tantalum, or tungsten, or molybdenum, or niobium, or any combinations thereof. The ceramic shell substantially uniformly encloses the metal core particulate. A method of making a core-shell particulate is provided. The method includes the steps of providing a metal core particulate; and disposing a ceramic shell including a transition metal composition onto the core particulate. An article including a plurality of core-shell particulates is also provided.

### BACKGROUND

Embodiments of the invention relate generally to core-shell particulates, and articles made therefrom. More particularly, the invention relates to core-shell particulates that are structurally and mechanically stable at high temperatures. The invention also relates to a method for making core-shell particulates and to articles made therefrom.

Core-shell particulates are of scientific and technological interest as they facilitate combination of different materials and hence different functionalities into a single entity. Core-shell particulates have been extensively used as structural materials. However, most of them fail to operate at high temperatures. There is an increased demand for materials capable of providing long-term stability, especially for applications involving high temperatures and high pressures. The major challenges in the synthesis of core-shell particulates are to synthesize core particulate of uniform size, and to coat them with uniform shell structures of a desired shell material. In spite of much effort, there is a need for core-shell particulates suitable for high temperature operations and versatile methods to fabricate such particulates.

### BRIEF DESCRIPTION

One aspect of the invention is to provide a core-shell particulate. The core-shell particulate includes a metal core particulate including a noble metal or a refractory metal; and a ceramic shell including a transition metal composition. The transition metal composition includes a material including hafnium, or zirconium, or yttrium, or tantalum, or tungsten, or molybdenum, or niobium, or any combinations thereof. The ceramic shell substantially uniformly encloses the metal core particulate.

In another aspect, the embodiments of the invention provide an article. The article includes a plurality of core-shell particulates. The core-shell particulate includes a metal core particulate including a noble metal or a refractory metal; and a ceramic shell including a transition metal composition. The transition metal composition includes a material including hafnium, or zirconium, or yttrium, or tantalum, or tungsten, or molybdenum, or niobium, or any combinations thereof. The ceramic shell substantially uniformly encloses the metal core particulate.

Another aspect of the invention is to provide a method of making a core-shell particulate. The method includes the steps of providing a metal core particulate; and disposing a ceramic shell including a transition metal composition onto the core particulate. The transition metal composition includes a material including hafnium, or zirconium, or yttrium, or tantalum, or tungsten, or molybdenum, or niobium, or combinations thereof.

### BRIEF DESCRIPTION OF DRAWINGS

These and other features, aspects, and advantages of the present invention will become better understood when the following detailed description is read with reference to the accompanying drawings in which like characters represent like parts throughout the drawings, wherein:

FIG. 1 is a schematic representation of a core-shell particulate according to one embodiment of the present invention;

FIG. 2 is a schematic representation of a core-shell particulate according to another embodiment of the present invention;

FIG. 3 is a schematic representation of a core-shell particulate according to yet another embodiment of the present invention;

FIG. 4 is a schematic representation of a high temperature composite including core-shell particulates according to one embodiment of the present invention;

FIG. 5 is an exploded view illustrating one embodiment of a high temperature composite including core-shell particulates for selective emission;

FIG. 6 is a schematic representation of a luminous element according to one embodiment of the present invention;

FIG. 7 is a schematic representation of a luminous element according to one embodiment of the present invention;

FIG. 8 is a schematic representation of a luminous element according to one embodiment of the present invention;

FIG. 9 is a schematic representation of a luminous element according to one embodiment of the present invention;

FIG. 10 is a schematic representation of a luminous element according to one embodiment of the present invention;

FIG. 11 illustrates an incandescent lamp including a high temperature composite configured as an emitter in accordance with one embodiment of the present invention;

FIG. 12 illustrates an incandescent lamp including a high temperature composite configured as an emitter in accordance with one embodiment of the present invention;

FIG. 13 is a flow chart of a method of making core-shell particulate, according to one embodiment of invention;

FIG. 14 is a scanning electron micrograph of Au—HfO(SO₄) core-shell particulates, synthesized according to one embodiment of invention; and

FIG. 15 is a scanning electron micrograph of Mo—HfO(SO₄) core-shell particulates, synthesized according to one embodiment of invention.

### DETAILED DESCRIPTION

In general, embodiments of the present invention include core-shell particulates, articles made therefrom and methods to make core-shell particulates. In the following description, numerous specific details are set forth in order to provide a thorough understanding of various embodiments of the present invention. However, those skilled in the art will understand that embodiments of the present invention may be practiced without these specific details, that the present invention is not limited to the depicted embodiments, and that the present invention may be practiced in a variety of alternative embodiments. In other instances, well known methods, procedures, and components have not been described in detail.

Furthermore, various operations may be described as multiple discrete steps performed in a manner that is helpful for understanding embodiments of the present invention. However, the order of description should not be construed so as to imply that these operations need be performed in the order they are presented, or that they are even order dependent. Moreover, repeated usage of the phrase “in one embodiment” does not necessarily refer to the same embodiment, although it may. Lastly, the terms “comprising”, “including”, “having”, and the like, as used in the present application, are intended to be synonymous and interpreted as open ended unless otherwise indicated.

In one embodiment a core-shell particulate is provided that includes a metal core particulate including a noble metal or a refractory metal and a ceramic shell including a transition metal composition. The transition metal composition may include a material including hafnium, or zirconium, or yttrium, or tantalum, or tungsten, or molybdenum, or niobium, or combinations thereof. In one embodiment, the ceramic shell substantially uniformly encloses the metal core particulate. As used herein, “substantially uniformly” implies that the thickness of the shell enclosing the metal core varies by not more than 50% over the surface of the metal core particulate. In one embodiment, the thickness of the shell enclosing the metal core varies by not more than 30%. In another embodiment, the thickness of the shell enclosing the metal core varies by not more than 20%. In yet another embodiment, the thickness of the shell enclosing the metal core varies by not more than 10%. Of course, one skilled in the art will recognize that an occasional defect is to be expected under bulk processing conditions, and so such variations are contemplated.

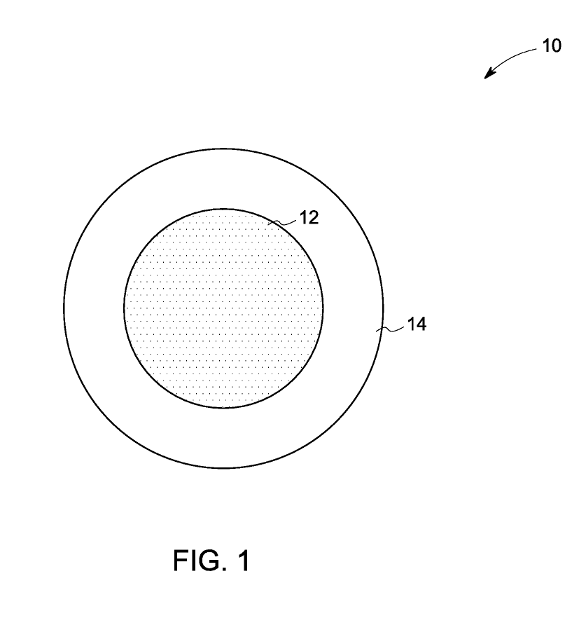

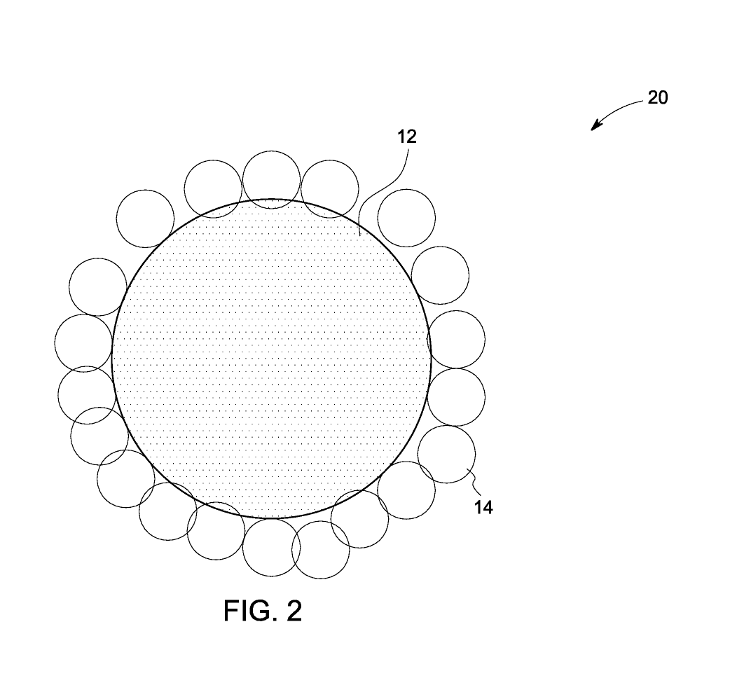

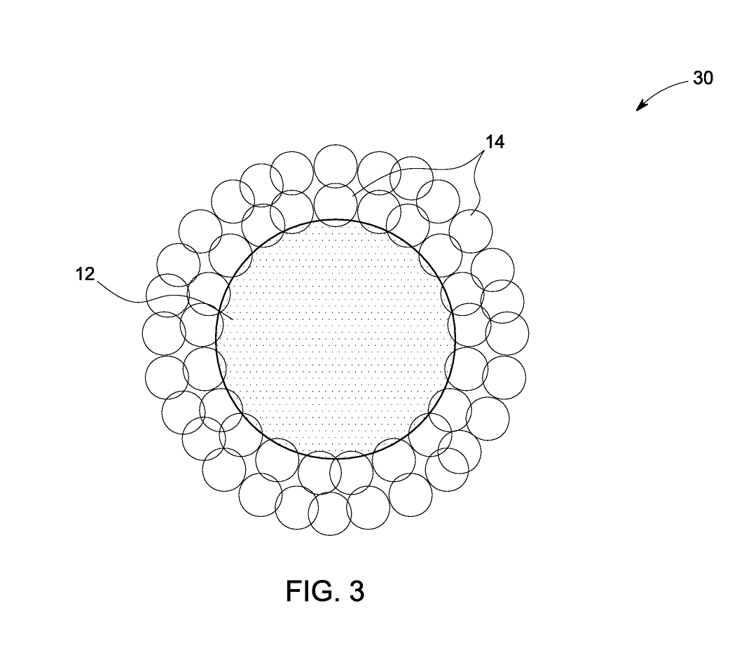

FIGS. 1-3 illustrate schematic representations of a core-shell particulate according to three different embodiments of the invention. As shown in FIGS. 1-3, each of the core-shell particulates includes a metal core particulate 12 substantially uniformly enclosed by a ceramic shell 14. In FIG. 1, the core-shell particulate 10 includes a ceramic shell 14 that encloses the metal core particulate 12 as a continuous layer. In FIG. 2, the core-shell particulate 20 includes a ceramic shell 14 formed from discrete particles. In certain embodiments, the ceramic shell 14 may be formed from a single layer (as shown in FIGS. 1 and 2) or from multiple layers. In an embodiment, where the ceramic shell includes multiple layers, the multiple layers may be formed from continuous layers, from discrete particles or a mix of continuous layers and discrete particles. FIG. 3 shows a core-shell particulate 30 made of multiple layers of discrete particles. In such embodiments including more than one layer, the shell may include multiple layers comprising the same shell material or multiple layers of different shell materials. For instance, a combination of shell materials over different layers could be chosen such that upon subsequent heat treatment, they homogenize to form another material. For example, yttria could be used as a first shell layer and hafnia could be used as a second shell layer so that upon heat treatment the two shells homogenize to form yttria-stabilized hafnia. Though the schematics herein show core-shell particulates as having a generally spherical shape, the particulates may instead have any desirable morphology such as, but not limited to, a triangle, a rectangle, a pentagon, a hexagon, a tripod, a platelet, a rod-like, an ellipsoidal, an elongated platelet, and a needle-like morphology. In certain embodiments, the metal core particulate may include a porous or a hollow metal core particulate. In certain embodiments, hollow metal core particulates may be further filled with gas fills as used for example, in conventional lamps.

In one embodiment, the material composition of the metal core particulate 12 and the ceramic shell 14 are suitable for high temperature operation. In accordance with one embodiment of the invention, the core-shell particulate is designed to remain stable at high temperatures, such as above about 2000 Kelvin and preferably above about 2300 Kelvin for certain applications. The core-shell particulate may be deemed ‘stable’ if the performance of the core-shell particulate does not appreciably degrade (e.g. due to vaporization) through exposure to such high temperatures for a stipulated design lifetime. The stipulated design lifetime for the core-shell particulate may depend upon the application in which the core-shell particulate is to be used. For example, in lighting applications, it may be desirable for the core-shell particulate to have a design lifetime spanning from as little as 10 hours up to and exceeding 1000 hours. In incandescent lamp applications for example, a reasonable design lifetime may be any length of time greater than about 100 hours to greater than about 750 hours, which is comparable to the performance of today's incandescent lamps.

The choice of the material composition for the metal core particulate 12 and the ceramic shell 14 may further be mutually dependent, as the physical and chemical properties of the two materials may need to be compatible for certain specific applications. For example, when utilizing these core-shell particulates to form a selective emitter for optical applications, the respective dielectric constants of the metal core particulate and the ceramic shell may need to meet certain criteria. In particular, the constituent materials of the metal core particulate and the ceramic shell may be selected to have a sufficient contrast in dielectric functions so as to selectively emit or transmit photons within at least one range of visible wavelengths. Further, the metal core particulate and the ceramic shell may be selected to be chemically and thermodynamically compatible. It has also been recognized herein that the ceramic shell material should be chemically stable when in contact with the enclosed core material at desired operating temperatures. That is, the ceramic shell material should not participate in an exchange reaction with the metal core particulate material, nor should the ceramic shell material dissolve an appreciable amount of the metal core material in solid solution. In one embodiment, the metal core particulate includes a refractory metal. In one embodiment, the metal core particulate may include tungsten, molybdenum, osmium, rhenium, and combinations of two or more thereof. In a particular embodiment, the core particulate includes molybdenum.

In another embodiment, the metal core particulate includes a noble metal. The noble metal may include gold, silver, platinum, or combinations of two or more thereof. In a particular embodiment, the metal core particulate includes gold. In certain embodiments, the metal core particulate may include an alloy of the above metals.

In one embodiment, the ceramic shell includes a transition metal composition. The transition metal composition may include a transition metal oxide, a transition metal nitride, transition metal carbide, a transition metal boride, a transition metal sulphate, a transition metal carbonitride, a transition metal borocarbide, a transition metal oxynitride, a transition metal oxysulfate, a transition metal hydroxysulfate, a transition metal hydroxynitrate, or one or more combinations of these materials. The transition metal may include hafnium, zirconium, yttrium, tantalum, tungsten, molybdenum, niobium, or combinations thereof. As used herein and unless otherwise noted, transition metals are intended to refer to elements corresponding to groups 3 to 12 (i.e., the d-block) of the periodic table of elements. In a specific embodiment, the transition metal composition includes hafnium oxide, zirconium oxide, yttrium oxide, tantalum oxide, tungsten oxide, molybdenum oxide, niobium oxide, or combinations thereof. In a particular embodiment, the transition metal composition includes a hafnium compound. The particular shell material chosen may further depend on the end use application of the core-shell particulates.

In certain embodiments, the core-shell particulates may be disposed onto a substrate. It has been recognized herein that the ceramic shell material should be chemically stable when in contact with a substrate such as a luminous element upon which it is disposed. That is, the ceramic shell material should not participate in an exchange reaction with the substrate material, nor should it dissolve an appreciable amount of the substrate material in solid solution.

The particular metals used for the metal core particulates and the particular ceramics used for the ceramic shell as described above, may be selected so as to provide selective emission functionality. For example, the core-shell particulates may be formed into a composite having an ordered, semi-ordered or unordered structure, so as to provide selective emission in a particular frequency range of the electromagnetic radiation spectrum. Such functionality may depend on the composition and spatial distribution of the metal core particulate and the ceramic shell, as will be discussed in further detail below. A set of material screening principles and design criteria for identifying novel material combinations and structural configurations for making a high temperature stable core-shell particulates for selective emission are described more in detail in co-pending patent applications U.S. patent application Ser. No. [11/394,499, Atty. Docket no. 165571-1] entitled HIGH TEMPERATURE CERAMIC COMPOSITE FOR SELECTIVE EMISSION; U.S. patent application Ser. No. [11/396,184, Atty. Docket no. 165571-2] entitled ARTICLE INCORPORATING A HIGH TEMPERATURE CERAMIC COMPOSITE FOR SELECTIVE EMISSION; and U.S. patent application Ser. No. [11/394,500, Atty. Docket no. 165571-3] entitled LIGHT SOURCE INCORPORATING A HIGH TEMPERATURE CERAMIC COMPOSITE FOR SELECTIVE EMISSION; and U.S. patent application Ser. No. [11/394,501, Atty. Docket no. 165571-4] entitled LIGHT SOURCE INCORPORATING A HIGH TEMPERATURE CERAMIC COMPOSITE AND GAS PHASE FOR SELECTIVE EMISSION.

In certain embodiments, the transition metal composition of the ceramic shell may include an additional material including calcium, or magnesium, or strontium, or barium, or cesium, or combinations of two or more thereof. These additional materials may advantageously stabilize the desired phase of the transitional metal composition. In one embodiment, the transition metal composition comprises an yttria stabilized hafnium compound. In another embodiment, the transition metal composition comprises a calcium stabilized hafnium compound.

The dimension of the core-shell particulates, and the individual dimensions of the metal core particulate and the ceramic shell regions may be designed according to the end use application. In one embodiment where the metal core particulates are not spherical, the metal core particulate has a largest dimension in the range from about 5 nanometers to about 250 nanometers. In another embodiment, the metal core particulate has a largest dimension of less than about 100 nanometers. In one embodiment, the ceramic shell has a thickness of less than about 500 nanometers. In another embodiment, the ceramic shell has a thickness in a range from about 100 nanometers to about 300 nanometers. When the ceramic shell includes multiple layers, the total thickness of the plurality of layers is generally within 500 nanometers. Typically, the dimensions of the core and the shell may be chosen such that the largest dimension of the core-shell particulate may be less than a particular value. In one embodiment, the core-shell particulate has the largest dimension of less than about 1 micrometer. In one embodiment, the core-shell particulate has the largest dimension of less than about 500 nanometers.

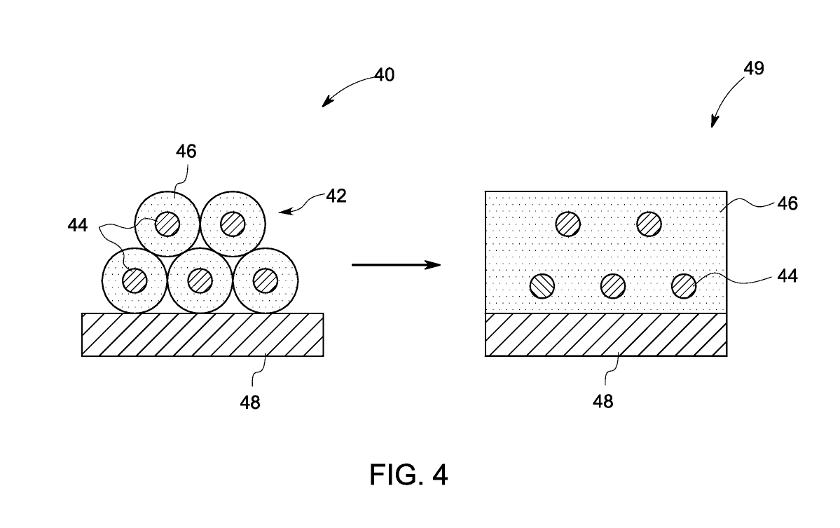

In accordance with one embodiment of the invention, a high temperature composite including the core-shell particulate described above is provided. FIG. 4 shows a schematic representation of a high temperature composite formed from a lattice 40 of core-shell particulates 42, according to one embodiment of the invention. In the embodiment illustrated in FIG. 4, the lattice of core-shell particulates may be configured in an opal lattice structure. The term “opal lattice” may refer to a close-packed ball lattice. The metal core particulate 44 may include any metal including those listed in the core-shell particulate embodiments above. In another embodiment, the core-shell particulates 42 may be formed into a single monolithic structure 49 by first assembling the core-shell particulates 42 and in turn sintering the particulate assembly. The shell 46 may include any ceramic listed in the core-shell particulate embodiments above. In one embodiment, the composition of the metal core and the ceramic shell are selected such that the high temperature composite has specific selective photon emission or transmission characteristics. In one embodiment, the wavelengths of radiation to be reflected, emitted or transmitted by the high temperature composite may be determined based upon the dielectric properties of the core and the shell materials and their relative distributions within the high temperature composite. Since the lattice spacing within the lattice 40 is a function of the size of the core-shell particulates 42, the size of the core particulate 44, and the dimension of the shell region 46, these parameters may be tailored to achieve the desired lattice properties.

In one embodiment, the high temperature composite may be designed for selective emission in a particular frequency range of the electromagnetic radiation spectrum. For example, in one embodiment, the high temperature composite is operable to reflect photons having a wavelength greater than about 700 nanometers and to emit or transmit photons having a wavelength between about 400 nanometers and about 700 nanometers when heated. In one embodiment, the core-shell particulates 42 may be assembled directly on a substrate such as the illustrated luminous element 48. As will be described in further detail below, although in certain embodiments the core-shell particulates may be coated or otherwise assembled on a substrate or luminous element, it is also envisioned that the core-shell particulates may be emissive without the need for such an underlying substrate or luminous element. In such a case, the core-shell particulates could be heated through direct application of current or through the use of inductive heating techniques, for example. In the above embodiments, the core-shell particulates may be assembled through one or more assembly techniques known or to be developed for assembling nanoparticles. For example, suitable assembly techniques for assembling the core-shell particulates may include but are not limited to self-assembly, spinning, dip coating, spraying, electrophoresis, and Langmuir-Blodgett techniques.

In one embodiment, the core-shell particulates described herein may be used in a variety of high-temperature applications. In one non-limiting example, the high temperature composite may be used in high temperature lighting applications such as those associated with incandescent lamps. The high temperature composite may form a part of a heating or luminous element. The luminous element may be coated with the high temperature composite or the luminous element may be self-emissive. The high temperature composite may contribute wholly or only in part to photon emission (i.e., becomes emissive) when heated. Further, the high temperature composite may be heated directly or through application of current to an underlying luminous element. If the high temperature composite is emissive, then it may be generally desirable to have high emittance in the visible radiation wavelengths and to have low emittance in the infrared radiation wavelengths.

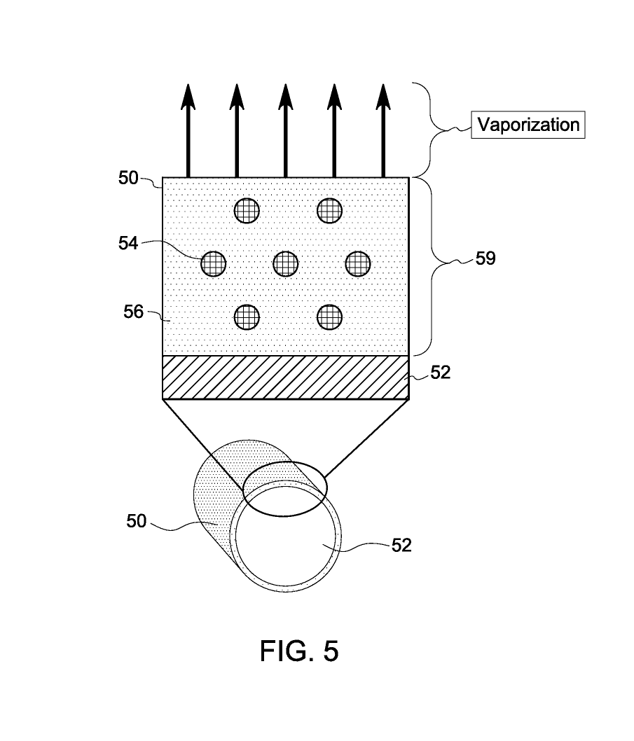

FIG. 5 is an exploded view illustrating one embodiment of a high temperature composite for selective emission in the form of a coating 50. As illustrated, the core-shell particulate may be coated on a heating element 52 as shown. In a non-limiting example, the heating element 52 may represent e.g., a rod, coil or ribbon formed from a material such as but not limited to carbon, tungsten, osmium, rhenium and molybdenum. As shown in the exploded view, the core-shell particulate may include a metal core particulate 54 and ceramic shell 56.

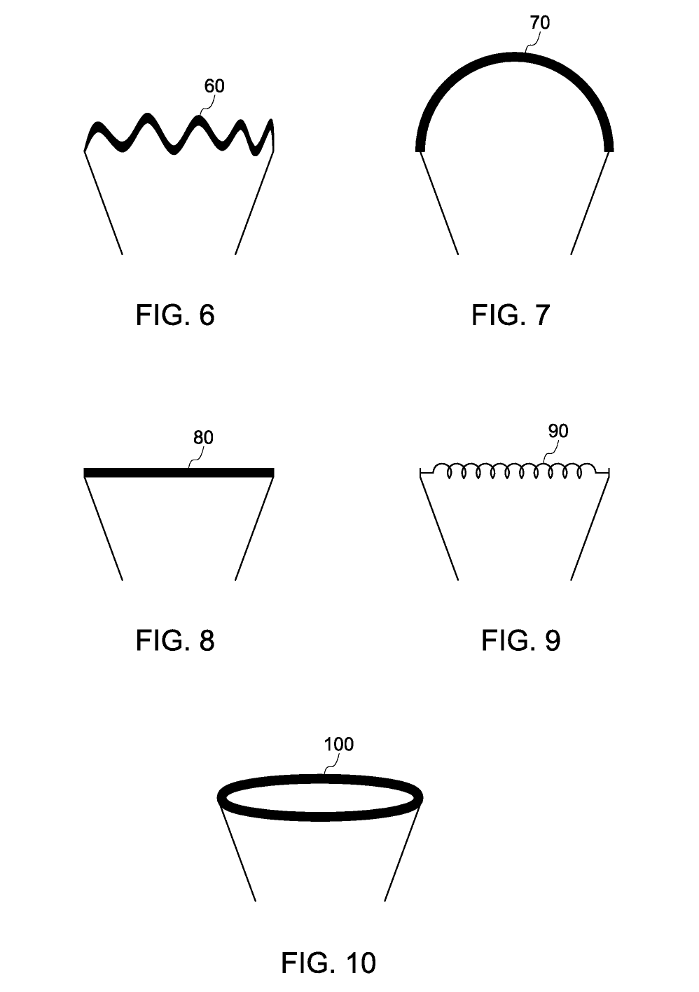

In a non-limiting example, the luminous element may be formed from a material such as but not limited to carbon, tungsten, osmium, rhenium and molybdenum. The luminous element in a radiation emitter may be formed in various shapes and structures such as but not limited to a planar structure or a coiled structure. Examples of various luminous element structures are illustrated in FIGS. 6 though 10. The luminous element structures depicted in FIGS. 6 through 10 are intended to be illustrative and not limiting. In one example, the luminous element may be a planar ribbon element 60 as shown in FIG. 6. The luminous element of FIG. 7 is a curved element 70. In another example, the luminous element may be a planar structure 80 as shown in FIG. 8. The luminous element illustrated in FIG. 9 represents a coiled element 90 which may be formed in a coiled-coil arrangement. In a further example, the luminous element may be a planar annular element 100 as shown in FIG. 10.

In one embodiment, the high temperature composite 50 may be configured such that during operation the high temperature composite 50 is not reduced in thickness (59) by an amount that would degrade performance of the high temperature composite 50 over a stipulated lifetime. In one embodiment, the high temperature composite 50 is configured such that performance of the high temperature composite does not degrade when heated to temperatures greater than about 2000 Kelvin and preferably greater than about 2300 Kelvin for periods of at least about 10 hours, preferably at least about 100 hours, and more preferably at least about 750 hours. In one embodiment, the thickness of the high temperature composite 50 may range between about 1 and 30 layers where a layer is defined by the diameter of the core-shell particulates. In one embodiment, the high temperature composite 50 may be coated on a luminous element having a diameter or cross-section measuring between about 25 microns and about 75 microns. The high temperature stability of the core-shell particulates described herein offer unique advantages under high temperature operation.

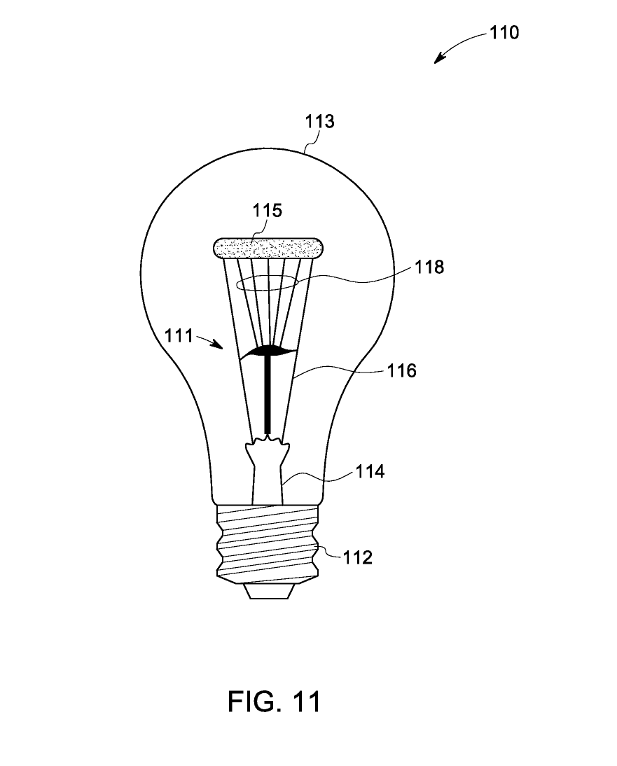

FIG. 11 illustrates a radiation source such as an incandescent lamp including a high temperature composite configured as a radiation emitter in accordance with one embodiment of the present invention. As illustrated in FIG. 11, incandescent lamp 110 may include a base 112, a light-transmissive envelope 113 coupled to the base 112, and the radiation emitter 111 including the luminous element 115 coupled to the base 112. The base 112 is where the electrical contact for the lamp is made and as such, may be fabricated out of any conductive material such as brass or aluminum. The light-transmissive envelope 113 may be fabricated out of glass and may take on any of a wide variety of shapes and finishes.

The radiation emitter 111 may be coupled to the base 112 and may include lead wires 116, support wires 118, and a stem press 114. The lead wires 116 carry the current from the base 112 to the luminous element 115. The lead wires 116 may be made of copper from the base 112 to the stem press 114 and may be made of nickel or nickel-plated copper from the stem press 114 to the luminous element 115. The stem press 114 may be a glass-based structure that holds the radiation emitter 111 in place. The stem press 114 may include an airtight seal around the lead wires 116. In order to balance the coefficients of expansion, the stem press 114 may further include a copper sleeve through which the lead wires 116 are passed. The support wires 118 are used to support the luminous element 115 and may be made from molybdenum, for example. The high emittance in the visible radiation wavelengths and low emittance in the infrared radiation wavelengths provided by the high temperature composite as described above may lead to better performance of the incandescent lamp 110.

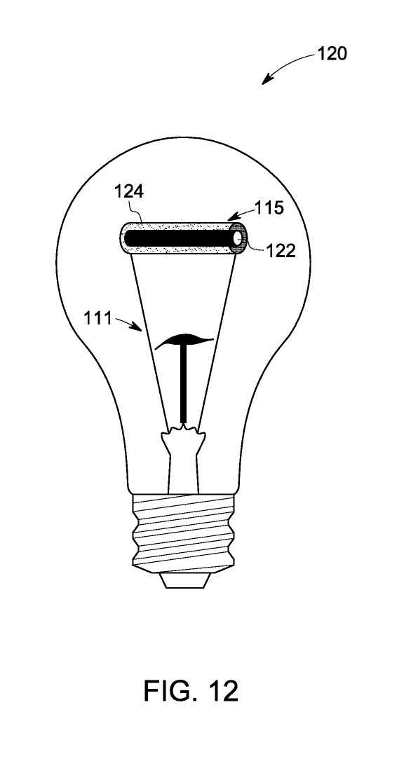

In the embodiment illustrated in FIG. 12, the incandescent lamp 120 is substantially similar to the incandescent lamp 110 of FIG. 11. However, the radiation emitter 111 of the incandescent lamp 120 includes a luminous element 115 that in turn includes a high temperature composite 124 disposed around or over a core 122. For example, the high temperature composite 124 may be coated directly on the core 122 or spaced apart from the core 122. The luminous element 115 may have various structures as described above. For example, the luminous element 115 may be a coiled element or a planar element. In one non-limiting example, the luminous element may be a double-coiled element including core 122 with the high temperature composite 124. In another non-limiting example, the high temperature composite may form an emitter with no direct electrical contact with the core 122 forming a filament. The emitter may be mechanically supported by the core 122 but not electrically connected to it. Moreover, the emitter may be indirectly heated by the radiation from the core 122 to in turn emit radiation.

In one embodiment, a core-shell particulate includes a metal core particulate comprising gold, and a ceramic shell including a hafnium compound substantially uniformly enclosing the metal core. The dimensions of the core and shell regions may be within those recited in the above embodiments, depending on the specific application requirement. As discussed above, the particular choice of the metal core and ceramic shell materials provide high temperature stability, mutual chemical and thermodynamic compatibility, and selective photon reflectance and emission characteristics.

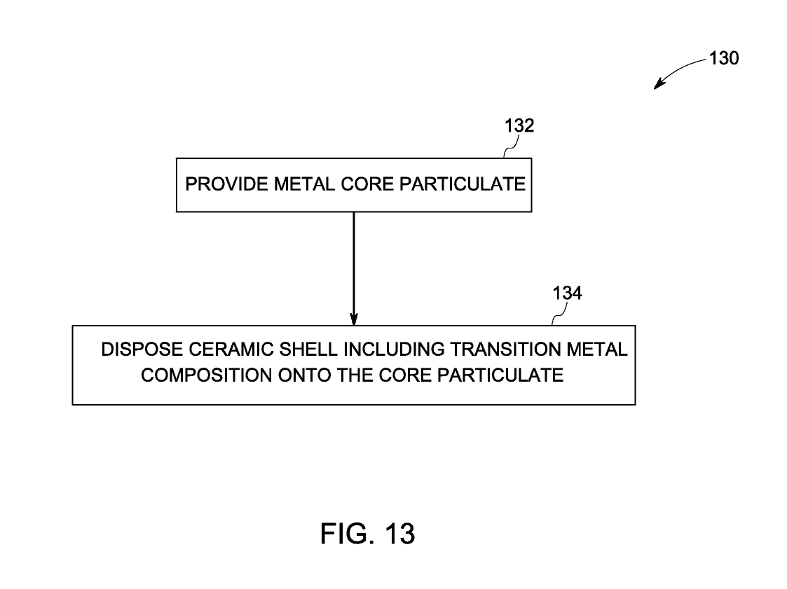

The core-shell particulates described herein may be made through one or more methods. In one embodiment, a wet chemical method is used. Wet chemical methods offer the advantages of good control over particle morphology, as well as provisions to control uniform disposition of shell around core particles. FIG. 13 is a flow diagram illustrating a method 130 for synthesizing core-shell particulates, according to one embodiment of the invention. The method 130 includes providing a metal core particulate (block 132) and disposing a ceramic shell including a transition metal composition onto the core particulate (block 134). In one embodiment, the transition metal composition includes a material including hafnium, or zirconium, or yttrium, or tantalum, or tungsten, or molybdenum, or niobium, or combinations thereof.

Any suitable method capable of yielding nanoparticles of metals having substantially uniform size and monodispersity may be used to synthesize the core particulates. Many wet chemical routes and vapor condensation methods are known to yield nanoparticles having a wide variety of sizes and morphologies, and having uniform particle size distribution. Many such metal nanoparticles are commercially available and may be used. In certain embodiments, the metal particles of any specific size may be selected by filtration before use. The core particulate may include tungsten, molybdenum, osmium, rhenium, gold, or combinations of two or more thereof. The dimensions of the core-particulates may be within those recited in the core-shell particulate embodiments. In one embodiment, the metal core particulate has largest dimension less than about 250 nanometers.

Typically, the metal core particulates are provided in step 132 as a dispersion of metal core particulates disposed in a liquid medium. In one embodiment, the liquid medium includes water, or alcohol, or methanol, or combinations thereof. In certain embodiments, the dispersion may include additional materials such as deagglomerants to prevent agglomeration of core particulates.

In certain embodiments, the metal core particulates may be surface modified to facilitate better precipitation of the shell material onto the core surface. Surface modification of the core particulate may be achieved by any suitable surface modification technique known or yet to be developed. In one embodiment, the metal core particulates are surface modified by mixing the dispersion of the metal core particulates with a surface modifying agent. Some examples of suitable surface modifying agents include, but are not limited to, an alkali sulphate, an alkaline earth-metal sulfate, a nitrate, a perchlorate, and combinations thereof. In a particular embodiment, the surface modifying agent includes a sulphate such as sodium sulphate or magnesium sulphate.

In one embodiment, the ceramic shell is disposed onto the metal core particulate in process block 134 by an in-situ process. When the process is in-situ, a shell material or an intermediate composition is precipitated onto the core particulate surface. To start with, a shell precursor material is added into the dispersion containing the core particulates, to form a mixture. The shell precursor may include a nitrate, a chloride, an alkoxide, an acetate an oxide, or combinations thereof.

In certain embodiments, it may be desirable to adjust the pH of the mixture to facilitate precipitation of the shell material or an intermediate composition onto the core particulate surface. In such embodiments, an acid may be introduced into the mixture. In one embodiment, the pH of the mixture is adjusted to a value less than about 5. Further, the mixture may be stirred for a duration in a range from about 10 hours to about 12 hours, in order to precipitate a ceramic shell comprising a transition metal composition onto the metal core particulate. In embodiments where an intermediate composition is precipitated, the intermediate composition of shell material may be converted into the desired phase of the shell material by heating to a reaction temperature. The heating temperature may vary and depends on the composition of the shell material. In general, the reaction temperature for many standard compositions is known or may be evaluated.

Precipitating the shell material onto the core-particulate surface includes precipitating a transition metal composition onto the core particulate surface. As described in detail above, the transition metal composition may be a transition metal oxide, a transition metal nitride, a transition metal carbide, a transition metal carbonitride, a transition metal boride, a transition metal sulphate, a transition metal carbonitride, a transition metal borocarbide, a transition metal oxynitride, a transition metal oxysulfate, a transition metal hydroxysulfate, a transition metal hydroxynitrate, or combinations thereof. As discussed in the core-shell particulate embodiment, the transition metal includes hafnium, zirconium, yttrium, tantalum, tungsten, molybdenum, niobium, or combinations thereof.

In a particular embodiment, the method includes the steps of providing a dispersion of metal core particulates in a liquid medium, mixing a surface modifying agent including sodium sulphate to the dispersion, adding a sufficient quantity of hafnium oxychloride to the dispersion, adjusting pH of the dispersion to a value less than about 5, and precipiting a ceramic shell including a hafnium compound onto the metal core particulate, to obtain a core-shell particulate.

The following example describes the preparation method for making a brittle-toughened epoxy composite. This example is merely illustrative, and the invention is not limited to this example.

### Example 1

### Synthesis of Gold-Hafnium Oxyhydroxy Sulphate (Au@Hf(OH)₂(SO₄)) Nanoparticles

Commercially available gold particles with average particle diameters of 100 nanometers were used for the experiment (From Microspheres-Nanospheres of Cold Spring, N.Y.).

To a 250 milliliters single-neck round bottom flask was added 8.8 milliliters of Na₂SO₄ (5.10⁶×10⁻³ Molar), 8.72 milliliters of H₂SO₄ (5.864×10⁻³ Molar), 61.23 milliliters of deionized water, and 7.45 milliliters of 100 nanometers Au particle stock solution that measured 29.4 mg Au/g by elemental analysis (ICP-MS). The reagents were added in the order as written above, and then HfOCl₂ was added within minutes after adding the Au stock solution. To the stirring solution of Au was drop-wise added 3.79 milliliters of a freshly prepared solution of HfOCl₂ at a rate of 3.15 milliliters/minute. The coating reaction was performed in air at room temperature, while stirring at maximum capacity, and was allowed to stir overnight. HfOCl₂.8H₂O stock solution was prepared by dissolving 0.416 g of HfOCl₂ in 25 ml DI water to make a 4.06×10⁻² M HfOCl₂ solution. HfOCl₂ was used within two hours of preparation. (100 nanometers Au cores were filtered through a 0.45 mm filter prior to ICP-MS analysis. Considering the stock solution was 29.4 mg Au/g, roughly 2.909×10⁹ nanoparticles are in each ml, and approximately 0.219 milligrams of Au particles were used in the synthesis).

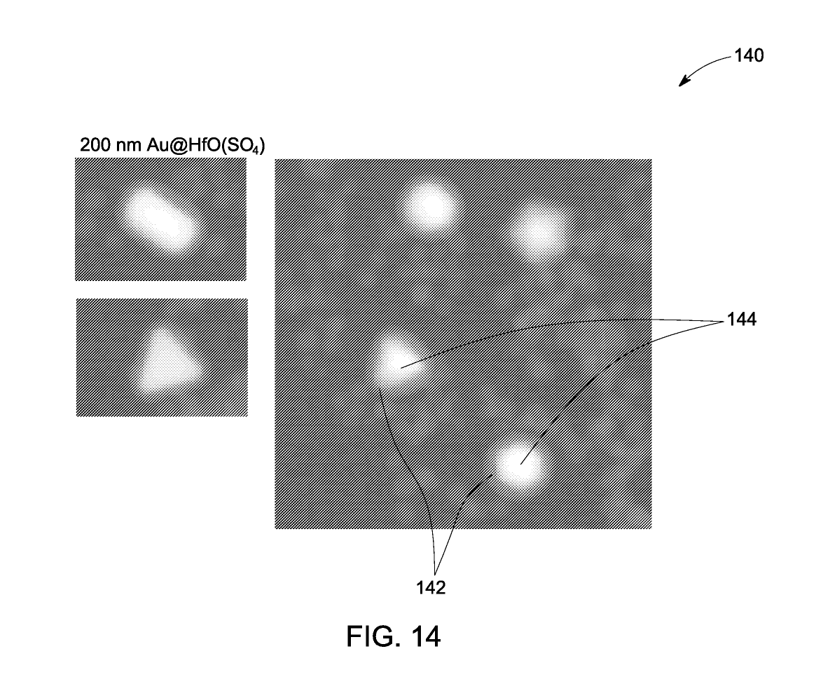

FIG. 14 is a scanning electron micrograph 80 of Au—HfO(SO₄) core-shell particulates, synthesized according to the procedure described above. The scanning electron micrograph along with elemental analysis indicated a uniform 37 (±4) nanometer shell of hafnium-oxy(hydroxy)sulfate (142) around the gold particles (144).

### Example 2

### Synthesis of Molybdenum-Hafnium Oxyhydroxy Sulphate (Mo@Hf(OH)₂(SO₄)) Nanoparticles

Commercially available molybdenum particles with average particle size of 100 nanometers were used for the experiment (supplied by Microspheres-Nanospheres).

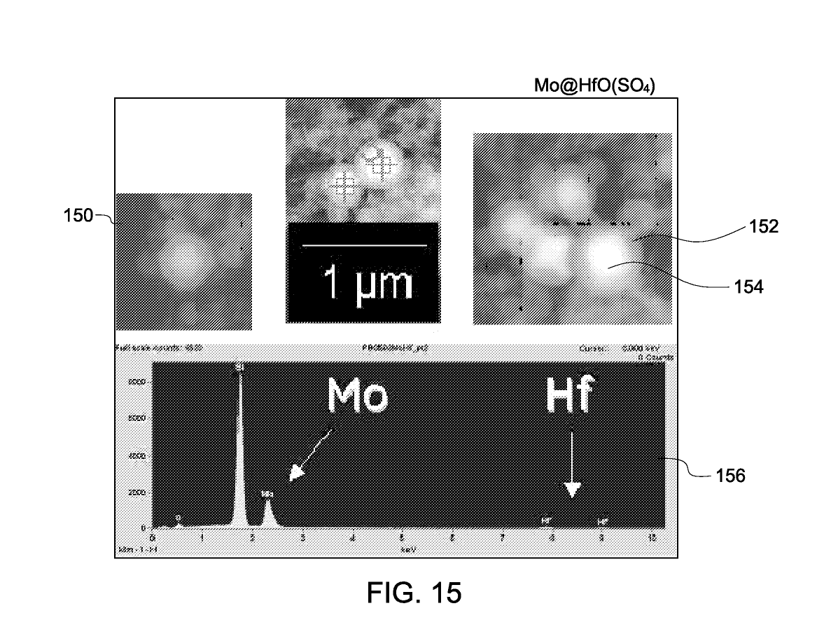

Mo@Hf(OH)₂(SO₄) nanoparticles were prepared using a procedure similar to one described in example 1. FIG. 15 is a scanning electron micrograph 150 of Mo—HfO(SO₄) core-shell particulates, synthesized according to the procedure described above. The scanning electron micrograph along with elemental analysis indicated a uniform nanometer shell (152) of hafnium-oxy(hydroxy)sulfate around the molybdenum particles (154). Plot 156 shows the elementary analysis done of the Mo@Hf(OH)₂(SO₄) nanoparticles. Peaks corresponding to molybdenum and hafnium may be clearly seen from the plot.

While only certain features of the invention have been illustrated and described herein, many modifications and changes may occur to those skilled in the art. It is, therefore, to be understood that the appended claims are intended to cover all such modifications and changes as may fall within the spirit and scope of the invention.

1. A core-shell particulate comprising:
a metal core particulate comprising a noble metal or a refractory metal; and
a ceramic shell comprising a transition metal composition, wherein the transition metal composition comprises a material including hafnium, or zirconium, or yttrium, or tantalum, or tungsten, or molybdenum, or niobium, or any combinations thereof, and wherein the ceramic shell substantially uniformly encloses the metal core particulate.

2. The core-shell particulate of claim 1, wherein the refractory metal comprises tungsten, molybdenum, osmium, rhenium, or combinations of two or more thereof.

3. The core-shell particulate of claim 1, wherein the noble metal comprises gold, silver, platinum, or combinations thereof.

4. The core-shell particulate of claim 1, wherein the transition metal composition comprises a transition metal oxide, a transition metal nitride, a transition metal carbide, a transition metal boride, a transition metal sulphate, a transition metal carbonitride, a transition metal borocarbide, a transition metal oxynitride, a transition metal oxysulfate, a transition metal hydroxysulfate, a transition metal hydroxynitrate, or combinations thereof.

5. The core-shell particulate of claim 4, wherein the transition metal comprises hafnium, zirconium, yttrium, tantalum, tungsten, molybdenum, niobium, or combinations thereof.

6. The core-shell particulate of claim 1, wherein the transition metal composition comprises an additional material including calcium, or magnesium, or strontium, or barium, or cesium, or combinations of two or more thereof.

7. The core-shell particulate of claim 1, wherein the transition metal composition comprises an yttria stabilized hafnium compound.

8. The core-shell particulate of claim 1, wherein the transition metal composition comprises a calcium stabilized hafnium compound.

9. The core-shell particulate of claim 1, wherein the transition metal composition comprises hafnium oxide, zirconium oxide, yttrium oxide, tantalum oxide, tungsten oxide, molybdenum oxide, niobium oxide, or combinations thereof.

10. The core-shell particulate of claim 1, wherein the metal core particulate's largest dimension is in the range from about 5 nanometers to about 250 nanometers.

11. The core-shell particulate of claim 10, wherein the metal core particulate is less than about 100 nanometers.

12. The core-shell particulate of claim 1, wherein the ceramic shell has a thickness of less than about 500 nanometers.

13. The core-shell particulate of claim 1, wherein the ceramic shell has a thickness in a range from about 100 nanometers to about 300 nanometers.

14. The core-shell particulate of claim 1, wherein the core-shell particulate is less than about 1 micrometer.

15. The core-shell particulate of claim 1, wherein the core-shell particulate is less than about 500 nanometers.

16. The core-shell particulate of claim 1, wherein the ceramic shell encloses the metal core particulate as a continuous layer or as discrete particles.

17. The core-shell particulate of claim 16, wherein the ceramic shell comprises a single layer or a plurality of layers.

18. A high temperature composite comprising the core-shell particulate of claim 1.

19. An article comprising the high temperature composite of claim 18.

20. The article of claim 19, wherein the article is a part of a luminous element or a heating element.

21. The high temperature composite of claim 18, wherein the high temperature composite is operable to reflect photons having a wavelength greater than about 700 nanometers and to emit or transmit photons having a wavelength between about 400 nanometers and about 700 nanometers when heated.

22. A lamp comprising a luminous element having the high temperature composite of claim 18 coated on the luminous element.

23. A core-shell particulate comprising:
a metal core particulate comprising gold, and
a ceramic shell comprising a hafnium compound substantially uniformly enclosing the metal core particulate.

24. A method comprising:
providing a metal core particulate; and
disposing a ceramic shell comprising a transition metal composition onto the core particulate, wherein the transition metal composition comprises a material including hafnium, or zirconium, or yttrium, or tantalum, or tungsten, or molybdenum, or niobium, or combinations thereof.

25. The method of claim 24, wherein providing the metal core particulate comprises providing a dispersion of metal core particulates disposed in a liquid medium.

26. The method of claim 25, wherein the liquid medium comprises a material including water, or alcohol, or methanol, or combinations thereof.

27. The method of claim 24, wherein providing the metal core particulate further comprises providing a surface modified metal core particulate disposed in a liquid medium.

28. The method of claim 27, wherein providing the surface modified metal core particulate comprises mixing a dispersion of a plurality of metal core particulates with a surface modifying agent.

29. The method of claim 28, wherein the surface modifying agent comprises a material including an alkali sulphate, or an alkaline earth-metal sulfate, or a nitrate, or a perchlorate, or combinations thereof.

30. The method of claim 28, wherein the surface modifying agent comprises sodium sulphate or magnesium sulphate.

31. The method of claim 24, wherein the metal core particulate comprises tungsten, molybdenum, osmium, rhenium, gold, or combinations of two or more thereof.

32. The method of claim 24, wherein the metal core particulate is less than about 250 nanometers.

33. The method of claim 24, wherein the disposing the ceramic shell onto the metal core particulate comprises introducing a shell precursor material into a dispersion containing the core particulates, to form a mixture.

34. The method of claim 33, wherein the shell precursor material comprises a nitrate, a chloride, an alkoxide, an acetate an oxide, or combinations thereof.

35. The method of claim 33, further comprising introducing an acid into the mixture in order to adjust pH to a value less than about 5.

36. The method of claim 35, further comprising precipitating a ceramic shell comprising a transition metal composition onto the metal core particulate.

37. The method of claim 36, wherein precipitating comprises precipitating a transition metal oxide, a transition metal nitride, a transition metal carbide, a transition metal carbonitride, a transition metal boride, a transition metal sulphate, a transition metal carbonitride, a transition metal borocarbide, a transition metal oxynitride, a transition metal oxysulfate, a transition metal hydroxysulfate, a transition metal hydroxynitrate, or combinations thereof, onto the metal core particulate.

38. The method of claim 37, wherein of the transition metal comprises hafnium, zirconium, yttrium, tantalum, tungsten, molybdenum, niobium, or combinations thereof.

39. A method comprising;
providing a dispersion of metal core particulates in a liquid medium;
mixing a surface modifying agent comprising sodium sulphate to the dispersion;
adding a sufficient quantity of hafnium chloride to the dispersion;
adjusting pH of the dispersion to a value less than about 5; and
precipiting a ceramic shell comprising a hafnium compound onto the metal core particulate, to obtain a core-shell particulate.
